(19) United States
(12) Patent Application Publication
(10) Pub. No.: US 2020/0002635 A1
(43) Pub. Date: Jan. 2, 2020

(54) ENVIRONMENTAL-FRIENDLY FUEL

(71) Applicant: YI-YI CHEN, TAINAN CITY (TW)

(72) Inventors: YI-YI CHEN, TAINAN CITY (TW); YU-WEI CHEN, TAINAN CITY (TW)

(21) Appl. No.: 16/023,227

(22) Filed: Jun. 29, 2018

(51) Int. Cl. C10L 5/40; B29C 43/00; C10L 10/02

(52) U.S. Cl. CPC C10L 5/406; B29K 2075/00; C10L 10/02; B29C 43/003

(57) ABSTRACT

An environmental-friendly fuel is provided which comprises 65 wt % to 95 wt % of a plurality of fine granules of recycled material mixed with 5 wt % to 35 wt % of a halogen-free flame retardant. The plurality of fine granules of recycled material are pulverized from waste polyurethane foamed material recovered from discarded objects.

### BACKGROUND OF THE INVENTION

### 1. Field of the Invention

The present invention relates to an environmental-friendly fuel formed from recycled material and in particular, converts a waste foamed material into an environmental-friendly fuel so as to achieve economic benefits.

### 2. Description of Related Art

Scrapped appliances containing refrigerant such as discarded refrigerators, refrigerated cabinets, air conditioners, and scrapped cars and motorcycles, have been classified as waste that should be recycled, but foamed materials are not listed as mandatory recycling items. Polyurethane (PU) material is widely used for making bumpers, instrument panels, armrests, and in conjunction with metal plates of cars, soles, furniture, window frames, sporting goods, boxes of electronics, athletics runways, and bicycle seats. A rigid foamed body of PU material has effects of isolation, packing, and bearing load and can be used for heat isolation of a refrigerator and a building. A flexible foamed body of PU material can be used for making furniture and mattresses during interior decorating. An elastic body having a microcell structure of PU material can be used for making soles and sporting goods. Currently, PU fillers dismantled from discarded electronics, scrapped cars and motorcycles are incinerated. The exhaust gas generated by incineration of the discarded PU foam contains nitrogen dioxide (NO₂) and toxic hydrogen cyanide (HCN), so it needs to be absorbed by water. The toxic cyanide ion (CN⁻) that is highly toxic and dissolved in the water after absorption must be further processed by a special treatment. Therefore, if a method of recycling the waste PU can be developed, it will not only enable the sustainable utilization of resources, but also prevent the burden and secondary pollution caused by PU incineration.

After heating, plural PU monomers are polymerized into a polymer having a network structure and the polymer does not become soft after another heating process, since its molecular structure has changed, and the polymer is considered as a common thermoset plastic. Resource recycling techniques suitable for a thermoset plastic include (1) manufacturing recycled plastic granules: this method cannot provide high quality PU material due to aging of the original PU product; (2) degradation of plastics for recycling: this treatment is not applied to industrial production yet, and only related research reports are published; and (3) manufacturing of refuse derived fuel (RDF): waste PU foam separated and recycled is used as a source of regenerated energy in this method, which can replace some fossil energy and reduce a cost of waste disposal.

Although the RDF is considered as a general fuel nowadays, it is derived from wastes, so the application of RDF still needs to be considered. The key factors include elevation of combustion efficiency, reduction of generating and emitting pollutants, and stability of the original combustion system after selection and recombination of the scrapped material. If the scrapped material can be manufactured to a refuse derived fuel successfully, waste can be properly handled and used to generate energy to achieve environmental protection and economic benefits.

### SUMMARY OF THE INVENTION

The present invention relates to an environmental-friendly fuel which converts a foamed material into an environmental-friendly fuel so as to achieve economic benefits.

The environmental-friendly fuel of the present invention comprises a plurality of fine granules mixed with 5 wt % to 35 wt % of halogen-free flame retardant, where the plurality of fine granules are pulverized from waste polyurethane foamed material. Accordingly, the otherwise useless abundantly available discarded or otherwise waste foamed material becomes useful.

According to an embodiment of the present invention, the environmental-friendly fuel is molded into a solid environmental-friendly fuel by heating, compressing and molding.

According to an embodiment of the present invention, the waste polyurethane foamed material is pulverized to obtain the fine granules, and 5 wt % to 35 wt % of the halogen-free flame retardant and 2 wt % to 6 wt % of an adhesion agent are added into the fine granules to obtain a solid flammable non-toxic environmental-friendly fuel.

According to an embodiment of the present invention, the adhesion agent is an aqueous based resin.

The manufacturing method of the present invention comprises the steps of pulverizing, mixing, molding, injecting and cutting. The pulverizing step comprises pulverizing a waste polyurethane (PU) material by a pulverizing equipment to obtain a pulverized waste PU material; the mixing step comprises placing the pulverized waste PU material into a stirring equipment and adding a specific amount of halogen-free flame retardant into the pulverized waste PU material to mix thoroughly to obtain a mixture; the molding step comprises placing the mixture into a molding equipment for heating, compressing and molding into a molded object; the injecting step comprises placing the molded object into a granulating device for heating and injecting to obtain an environmental-friendly fuel; and the cutting step comprises cutting the environmental-friendly fuel to a needed specific length.

Preferably, in the injecting step, a specific amount of the adhesion agent is added into the molded object when the molded object is placed into the granulating device so that the adhesion agent can be mixed with the molded object for heating and injecting.

### BRIEF DESCRIPTION OF THE DRAWINGS

FIG. 1 is a flow chart for manufacturing an environmental-friendly fuel according to the present invention;

FIG. 2 is a first schematic diagram showing a present invention molded into a round bar;

FIG. 3 is a schematic diagram showing a present invention molded into a block;

FIG. 4 is a schematic diagram showing a present invention molded into a sheet.

### DETAILED DESCRIPTION OF THE PREFERRED EMBODIMENT

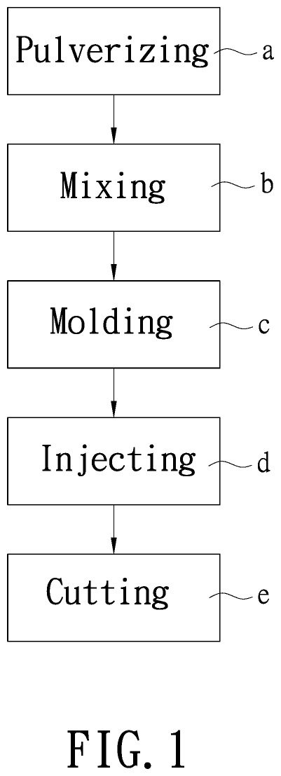

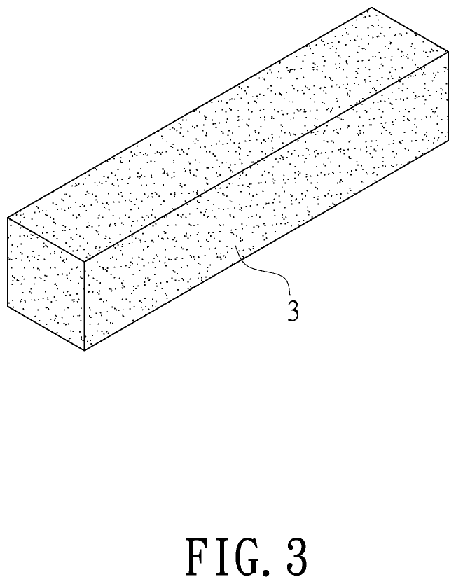

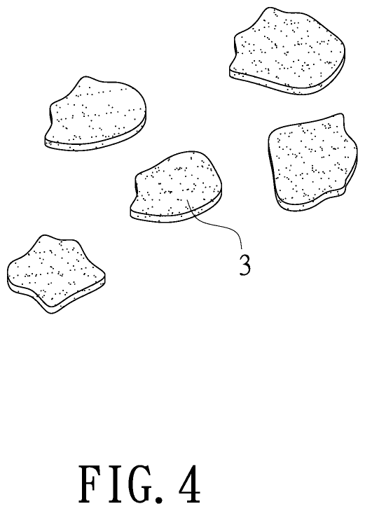

Referring to FIG. 1 to FIG. 4, the present invention is mainly made of waste polyurethane (PU) foamed materials. The manufacturing process of the present invention comprises pulverizing the waste PU foamed material into fine granules, and adding a specific amount of halogen-free flame retardant into the fine granules to mix thoroughly to obtain a flammable non-toxic environmental-friendly fuel.

During combustion, the specific amount of the halogen-free flame retardant added into the waste PU foamed material can prevent interaction of the waste PU material and air to reduce generation of a harmful gas. However, excessive amount of the halogen-free flame retardant will make the waste PU foamed material unable to burn, so the amount of the halogen-free flame retardant added must be controlled. In the present invention, a preferable percentage of the halogen-free flame retardant added is obtained by conducting numerous experiments. The present invention comprises 65 wt % to 95 wt % of the waste PU foamed material mixed with 5 wt % to 35 wt % of the halogen-free flame retardant, which achieves a spontaneous combustion effect of the waste PU foamed material and can be used as a fuel.

Furthermore, the environmental-friendly fuel described above can be molded into a solid body by heating and compressing. If adherence of the waste PU foamed material is not strong enough to mold into a solid body, 2 wt % to 6 wt % of an adhesion agent can be added into 59 wt % to 93 wt % of the waste PU foamed material mixed with 5 wt % to 35 wt % of halogen-free flame retardant to obtain a mixture, and then the mixture is further molded into a solid environmental-friendly fuel by heating, compressing and molding. Preferably, the adhesion agent is an aqueous based resin.

The environmental-friendly fuel described above can be manufactured by plural methods, a preferred embodiment to manufacture the present invention is disclosed below.

The manufacturing method of the present invention comprises pulverizing, mixing, molding, injecting and cutting:

(a) the pulverizing step comprises pulverizing waste PU foamed material by a pulverizing equipment to obtain a pulverized waste PU material;

(b) the mixing step comprises placing the pulverized waste PU material into a stirring equipment and adding a specific amount of halogen-free flame retardant to mix thoroughly to obtain a mixture;

(c) the molding step comprises placing the mixture into a molding equipment for heating, compressing and molding to obtain a molded object;

(d) the injecting step comprises placing the molded object into a granulating device for heating and injecting to obtain an environmental-friendly fuel (1); and

(e) the cutting step comprises cutting the environmental-friendly fuel into a specific length.

Referring to FIG. 1 to FIG. 3, the pulverizing step (a) comprises placing waste PU foamed material into pulverizing equipment such as a chamfering machine or a pulverizer for pulverizing and obtaining a pulverized waste PU material in which a plurality of waste PU fine granules is preferred. The mixing step (b) comprises placing the pulverized waste PU material into a stirring equipment such as a ball type mixer and adding a specific amount of a halogen-free flame retardant into the pulverized waste PU material, in this embodiment, 65 wt % to 95 wt % of the pulverized waste PU material is mixed with 5 wt % to 35 wt % of the halogen-free flame retardant thoroughly to obtain a mixture which can be used as an environmental-friendly fuel powder.

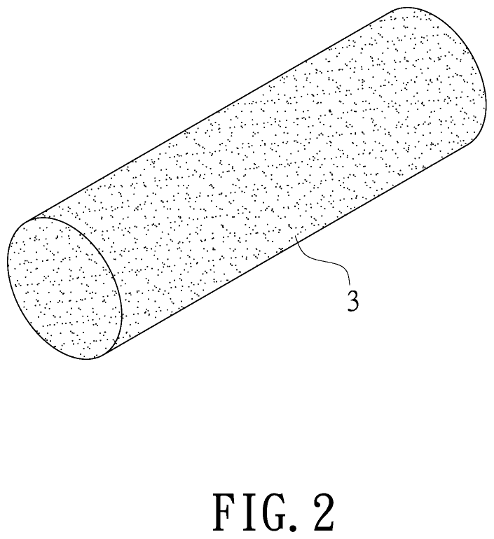

The molding step (c) can be further performed when a solid environmental-friendly fuel is needed. The molding step (c) comprises placing the mixture into molding equipment such as a dual-cylinder machine or a kneader reactor for heating, compressing and molding to obtain a molded object with high density. The molded object is further processed by an injecting step (d) which comprises placing the molded object into a granulating device for heating and injecting to obtain the solid environmental-friendly fuel (1) having different appearances, such as a ball, a round bar, a block, a sheet and granules demonstrated in FIG. 2 to FIG. 4. The cutting step (e) is then conducted to cut the solid environmental-friendly fuel (1) into a needed specific length.

In addition, to increase density of the molded object and achieve better injecting and molding effects, a specific amount of adhesion agent is added into the molded object when the molded object is placed into the granulating device in the injecting step (d) so that the adhesion agent can be mixed with the molded object for heating and injecting. When the adhesion agent is used in manufacturing the environmental-friendly fuel, the amount of halogen-free fire retardant is not changed to maintain the character of reducing generation of a harmful gas, and the amount of the waste PU foamed material added is slightly reduced. In such case, 59 wt % to 93 wt % of the waste PU foamed material is mixed with 5 wt % to 35 wt % of the halogen-free fire retardant in the mixing step, and 2 wt % to 6 wt % of the adhesion agent is added in the injecting step (d) to obtain a non-friable environmental-friendly fuel, in which the adhesion agent is an aqueous based resin.

Characteristics of the environmental-friendly fuel in the present invention and two traditional fuels (wood granules and coal) are tested by Société Générale de Surveillance (SGS S.A.), and the testing results are showed in Table 1. In Table 1, “EF” is the abbreviation of “environmental-friendly fuel of the present invention”, “WG” is the abbreviation of “wood granules”, “C” is the abbreviation of “coal”, and “DIN” is the abbreviation of “DIN EN ISO standards”.

TABLE 1
SGS testing results (Date: 2017 Jun. 9)

| Test item(s) | Unit | EF | | WG | | C | DIN | Annotation |
|---|---|---|---|---|---|---|---|---|
| Total moisture | wt % | 4.23 | | 8.31 | | 28 | <12% | A substance having a low |
| Inherent moisture | wt % | 2.7 | | 7.55 | | 22 | 7~8% | moisture indicates that |
| | | | | | | | | it has a high combustion |
| | | | | | | | | efficiency and use efficiency. |
| Chloride | wt % | 0.0016 | | 0.006 | | 0.3 | <0.015% | When the chloride content is |
| | | | | | | | | lower than 0.015%, a dioxin |
| | | | | | | | | test is not needed. |
| Phosphorus | wt % | 3.42 | | — | | — | — | |
| | | A.D. | D.B. | A.D. | D.B. | — | — | |
| Ash | wt % | 2.78 | 2.86 | 1.06 | 1.115 | 10~15 | — | A substance having higher |
| | | | | | | | | percentage of volatile matter |
| Volatile matter | wt % | 79.81 | 82.02 | 74.77 | 80.88 | 37 | — | and lower percentage of ash |
| Fixed carbon | wt % | 14.71 | 15.12 | 16.62 | 17.98 | 37 | <20% | and fixed carbon indicates it |
| | | | | | | | | has higher heating efficiency |
| Total sulfur | wt % | 0.09 | 0.09 | 0.03 | 0.03 | 0.3 | <0.08 | Sulfur dioxide human stimulates |
| | | | | | | | | respiratory system, induces metal |
| | | | | | | | | corrosion and reduces use life of |
| | | | | | | | | boilers. |
| Total heating | Kcal/kg | 6042 | 6210 | 4416 | 4777 | 5800 | — | A substance having higher heating |
| value | | | | | | | | values indicates it has a better |
| | | | | | | | | combustion efficiency. |

Furthermore, “A.D” is the abbreviation of “air dried basis” in which the sample is dried at room temperature to evaporate surface moisture of the sample; and “D.B” is the abbreviation of “dried basis” in which the sample is dried by a dryer. Moisture of a D.B. sample is lower than moisture of an A.D. sample.

According to Table 1, total moisture and inherent moisture of the present invention are lower than the wood granules and coal, it suggested that the present invention has a higher combustion efficiency and higher using efficiency per kilogram (kg) than the wood granules and coal. In such case, 1 kg of the present invention has a lower fuel cost. The chloride content in the present invention is 0.0016 wt % that is 1/10 of the inspection criteria in the DIN EN ISO standards which indicates the present invention is nearly non-toxic. In addition, the volatile matter in the present invention is about 82.02 wt %, and contents of the ash and the fixed carbon are low which indicate that the present invention has efficacies of a high heating efficiency, a low cost for cleaning boilers and residues, and a less influence of subsequent usage of the boilers. At last, the present invention has a highest total heating value of 6201 Kcal/kg and a best combustion efficiency among the three tested objects which indicates that the present invention decreases fuel cost when mass produced.

In summary, the present invention has advantages compared to the existing structure as below:

1. The halogen-free fire retardant mixed with the waste PU foamed material can prevent generation of toxic gas and toxic substances foamed during combustion.

2. The halogen-free fire retardant has characters of low smokiness, low toxic gas generation, reduction in flammability of inflammable materials and combustible matter, impeding ignition of the foamed material and inhibition of flame spreading, which can prevent interaction of the waste PU foamed material and external air to decrease generation of toxic gas during combustion, and achieves an efficacy of non-toxic combustion.

3. The adhesion agent added in the present invention increases density of the molded object to improve a molding effect after injection molding, and an environmental-friendly fuel having higher adherence can be obtained.

1. An environmental-friendly fuel, comprising a mixture formed by 65 wt % to 95 wt % of a plurality of fine granules of pulverized waste polyurethane foamed thermoplastic material recovered from discarded objects mixed with 5 wt % to 35 wt % of a halogen-free flame retardant, the mixture being molded to form a refuse derived environmental-friendly fuel.

2. The environmental-friendly fuel as claimed in claim 1, wherein the mixture is molded into the refuse derived solid environmental-friendly fuel by heating the mixture, compressing the heated mixture and injection molding.

3. An environmental-friendly fuel, comprising a mixture formed by 59 wt % to 93 wt % of a plurality of fine granules of pulverized waste polyurethane foamed thermoplastic material recovered from discarded objects, 5 wt % to 35 wt % of a halogen-free flame retardant and 2 wt % to 6 wt % of an adhesion agent, the mixture being molded to form a refuse derived environmental-friendly fuel.

4. The environmental-friendly refuse derived fuel as claimed in claim 3, wherein the adhesion agent is an aqueous based resin.
